(19) United States
(12) Patent Application Publication
(10) Pub. No.: US 2006/0067172 A1
(43) Pub. Date: Mar. 30, 2006

(54) Sound effects method for masking delay in a digital audio player

(76) Inventors: John Robert Berkheimer, Scottsdale, AZ (US); Miles Martin Elmers II, Phoenix, AZ (US)

Correspondence Address: TYRELL CORPORATION;C/O THE HILL LAW FIRM PLC, 7035 NORTH 23RD AVE, PHOENIZ, AZ, 85021, US

(21) Appl. No.: 11/230,954

(22) Filed: Sep. 19, 2005

Related U.S. Application Data
(60) Provisional application No. 60/610,875, filed on Sep. 17, 2004.

(51) Int. Cl. G11B 17/22

(52) U.S. Cl. 369/30.3

(57) ABSTRACT

The present invention is a method for enhancing playback of digital audio data by playing sound effects stored in a digital audio player's memory. The sound effects are preferably loaded into a playback memory just before an MPU of the player starts to perform a task that normally results in a silent processing delay, such as locating digital audio data. By parallel processing a sound effect with a time consuming task performed by the MPU, the processing delay is not noticed by a user. In addition to filling an otherwise silent interval of time with some sort of entertainment, the sound effects can be used to emulate some of the sounds made by a vintage juke box, such as the crackling of a needle on a record. In an alternative embodiment, the sound effects are stored in a song database such that there can be particular sound effects that are used when a particular song database is to be accessed. For seamlessly playing a song right after a sound effect, the digital audio data of a song selection can be streamed to the same playback memory that is used for playback of the sound effect.

### CROSS REFERENCE TO RELATED APPLICATION

The present application is related to and claims priority under 35 U.S.C. 119(e) to U.S. Provisional Patent Application Ser. No. 60/610,875 filed Sep. 17, 2004, entitled “DIGITAL AUDIO PLAYER”, the contents of which are hereby incorporated by reference in their entirety.

### BACKGROUND OF THE INVENTION

In the past, users of vintage juke boxes were content to wait for a short period of time between their selection of a song and the actual initiation of playback because the interval was filled with observable operations of the machine, such as a mechanical arm grasping a record disc, moving it to the turntable location, and dropping the needle. A juke box's song library was printed on pages, often with a flipping mechanism, and each song was assigned an access code such as “J7” or “512”. The track selection keys were part of a complicated mechanism that made very distinct sounds when pressed to select a music selection. Music was played back from records. Even today, the large-scale mechanical operations involved in loading a record onto a turntable are visually entertaining, and the audible mechanical movements within a vintage juke box assure a user that the unit is working to prepare a music selection for playback. Moving a record onto a turntable involves considerable mechanical component movement, and a vintage juke box appears to do a very precise job, so most users don't mind waiting for a while to hear music. Juke box systems are still popular, such as those shown and described in U.S. Pat. Nos. 6,031,795 and 6,587,403, but many modern juke boxes use CD's instead of records for the playback of music, which may increase the number of selections available in some systems.

With the advent of digital music compression technology, such as the MP3 and WMA formats, the basic functionality of these juke boxes can now be carried in your pocket, but there are no large moving parts that suggest what the device is doing, and the operation of the device is virtually silent, so the only feedback to a user that indicates that the device is working is usually a small LCD screen. Many people miss the reassuring feedback provided by the sound of gears and ratcheting, as well as the crackling sound of a record needle dropping on the record, which has been eliminated through the use of digital storage sources of music. Even though these devices are silent, they often exhibit delays in operation while the device locates a track to be played. Search delays can be made worse by the small simple processors commonly used in low cost portable players.

### SUMMARY OF THE INVENTION

In order to mask some of the silent processing delays associated with a modern MP3 based juke box while replicating some of the famous characteristics of a vintage juke box, we have added sound effects to a modern juke box. The mechanical movements, whirring sounds and crackling needle sounds of a “vintage” 50's juke box are preferably queued for playback just before the MPU processes the location of a music selection. The result is that sounds are heard by a user rather than silence during the delays associated with locating data. Most of the memorable characteristics of vintage juke boxes can now be enjoyed on a modern juke box that has all the benefits of the operation of a digital audio player having improvements that enhance functionality and ease of use. In a similar manner, sound effects that emulate the sound of key presses can be added, but those sounds must play immediately so that they coincide with actual key presses. In another embodiment, the feedback sounds could be verbal responses such as “great song!” or “lets play some music!” This feedback could be very reassuring to children or other less technical users who might be concerned during the silence of a processing delay.

### BRIEF DESCRIPTION OF THE DRAWINGS

FIG. 1 is a perspective view the appearance of a juke box that incorporates the most preferred embodiment of the present invention.

FIG. 2 is a system block diagram showing a computer architecture in which the present invention may be implemented.

FIG. 3 is a flowchart showing some of the processing that may be performed in the main software loop of a digital audio file storage and playback unit in accordance with a preferred embodiment of the present invention.

FIG. 4 is flowchart showing some of the processing that may be performed in the execute command step of the main software loop of FIG. 3.

FIG. 5 is flowchart showing some of the processing that may be performed in the process select key step of the execute command step of FIG. 4.

FIG. 6 is flowchart showing some of the processing that may be performed in the initiate playback step of the execute command step of FIG. 4.

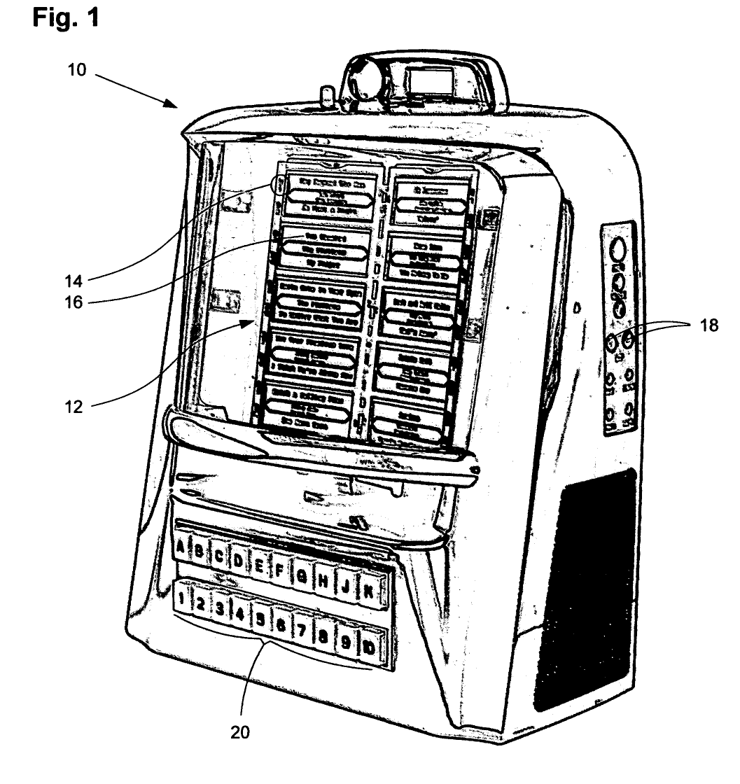

The following is the menu of numerical callouts used in FIGS. 1-6:
10 Jukebox
12 Printed flipping pages
14 Access code
18 Skip buttons
16 Song title
20 Track selection keys
50 Power supply
52 Sound effect
54 MPU (micro processor unit)
56 Digital audio storage unit
58 Amp and digital audio decoder
60 Speakers
70 Initialization
72 Key press
74 Process key press
76 Execute command
78 Stop mode
80 Determine next track
82 Update displays
84 Power failure
86 System key
88 Process system key
90 Select key
92 Process select key
94 Start play
96 Initiate playback
100 First select key
102 Begin code
104 First key sound
106 Complete code
108 Second key sound
110 Set to play
120 Whirr sound
122 Needle sound
124 Locate data
126 Start stream

### DETAILED DESCRIPTION OF THE INVENTION

The most preferred embodiment of the present invention, shown in FIG. 1, is a mobile or portable juke box 10 designed for storage and playback of digital audio files, and it combines our sound effects method for emulating a vintage juke box while creating the perception that there is not really a delay caused by the processing time of an MP3 player. By making a stronger association with a vintage juke box, the expectations of a user will hopefully be lower even though the system is a digital audio system that is controlled at least partially by a computer processing means capable of playing digital audio files. Our sound effects method creates a distraction that mimics juke box noises that have held the interest of many juke box users in the past, and that distraction changes a user's perception of the internal workings of our juke box unit so that any extra time it takes to process is viewed as being the normal wait time for a juke box. If everything is viewed as being normal, a user is less likely to start pressing buttons out of frustration because it seems like a new digital audio juke box should be faster.

Those of ordinary skill in the art will appreciate that the appearance shown in the various figures may vary depending on the system implementation. For example, the software structure may have many additional steps that are not shown, or the steps may be arranged in a different order. The depicted examples are not meant to imply architectural limitations with respect to the present invention. The digital audio files may exist in compressed data formats, such as MP3, WMA, Real-Audio, or other suitable audio compression formats, or the files may exist in uncompressed format, which allows playback of standard format CD-DA compact discs. Decoding of compressed audio may be done by dedicated hardware, or may be done with a general purpose DSP. Although this description will discuss our most preferred embodiment, these preferences are not intended to exclude suitable or functionally equivalent alternatives.

To operate the juke box 10 shown in FIG. 1, a user browses song titles 16 displayed on a menu 12. The menu is typically maintained on numerous printed flipping pages, similar to a vintage juke box. Adjacent each of the song titles, there is an access code 14 that is at least partially comprised of symbols, preferably one alpha symbol and one numeric symbol. Access codes may be entered by a user to request playback of digital audio files associated with song titles. A user may enter a song selection by actuating a combination of track selection keys 20 bearing the symbols of the access code identified with a song title. The term “track selection keys” includes, but is not limited to, buttons and pushbuttons.

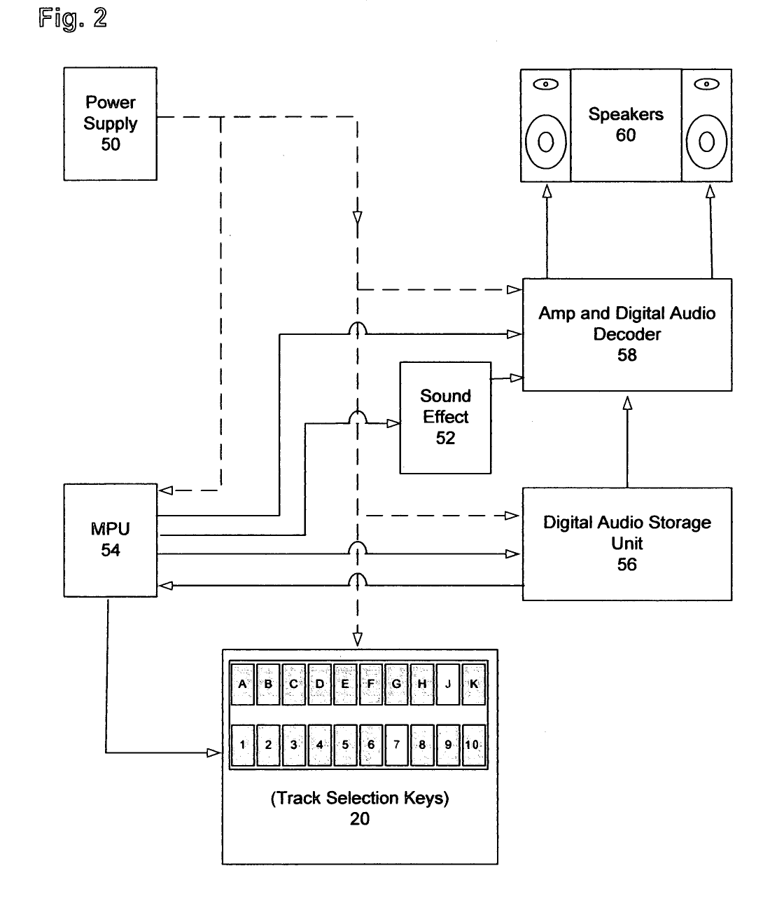

The juke box is controlled using a computer processing means for processing data. The computer processing means is capable of scanning track selection keys, playing related audio files, and otherwise controlling the electronic functions of the juke box unit. A preferred data processing system, shown in the block diagram of FIG. 2, is a digital audio system with a basic computer architecture. Those of ordinary skill in the art will appreciate that the hardware may vary depending on the system implementation, and this description is not meant to imply architectural limitations. For example, the system may have one or more processors, and other peripheral devices may be used in addition to or in place of the hardware described.

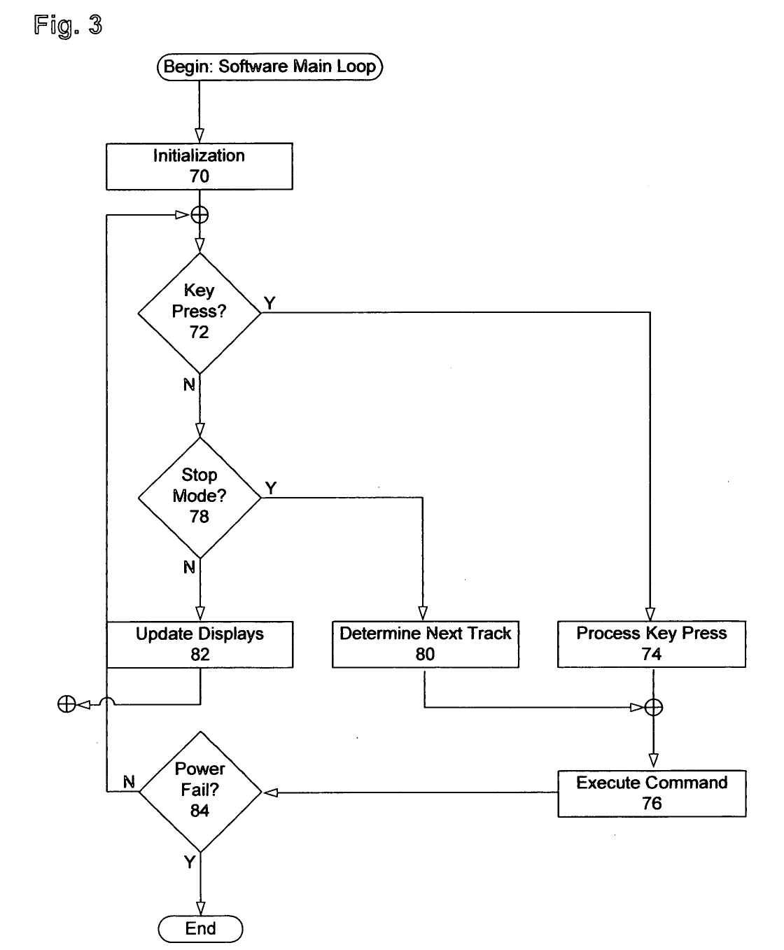

The data processing system is controlled by an MPU (micro processing unit) 54 that scans a large array of switches, allowing a user to control the system. Power to the system is provided by a power supply 50. The MPU can be a common controller, such as an Intel 8051 eight bit microcontroller, which integrates the memory and other peripherals required into a single inexpensive chip. One group of the scanned switches forms the track selection keys 20. Sound generation is usually done by an asynchronous subsystem which frees the MPU from time critical playback tasks. This audio subsystem usually contains a playback memory to store the sound to be generated. Often a decoder is integrated to allow the direct playback of compressed data. The MPU can quickly load the playback memory and initiate several seconds of audio playback. Once playback is initiated, the MPU is free to continue scanning for keys and locating the next segment of audio to be played. Sound effects 52 can be stored either in system memory, along with the main control program, or they can be stored along with the song database. The MPU controls the digital audio storage unit 56, as well as controlling generation of sound effects. Based on a user's selection, the system provides audio streams to an amp and digital audio decoder 58 that drives speakers 60.

Where a user's selection is from a database, the possible databases may be stored in any form of digital memory, including CD, hard drive, or FLASH. In addition to being able to be implemented on a variety of hardware platforms, the present invention may be implemented in a variety of software environments. A typical operating system or software runtime environment may be used to control program execution within the data processing system. FIG. 3 shows a flowchart of a preferred main loop of an operating system suitable for the computer processor of the present invention. The main loop, which shows some of the processing that may be performed by the MPU, is the highest level of the software. The main loop begins when power is applied from a power supply. The system performs a startup Initialization step 70. The MPU then scans keys, including the track selection keys, until the system detects a key press 72 from a user. When a key press is detected, there is a process key press step 74 that causes the system to execute a command 76, such as to process keys, to initiate playback of an audio file, or to power on the system. Unless there is a power failure 84, once a command is executed the system waits to detect the next key press. If no next key press is detected, then the system tests for entry into a stop mode 78, which is usually when an audio file has completed playback and the system must now determine the next track 80, if any, to be played. If stop mode is not detected, then the system will update displays 82, such as an LCD screen. This main loop never ends unless power to the system is lost.

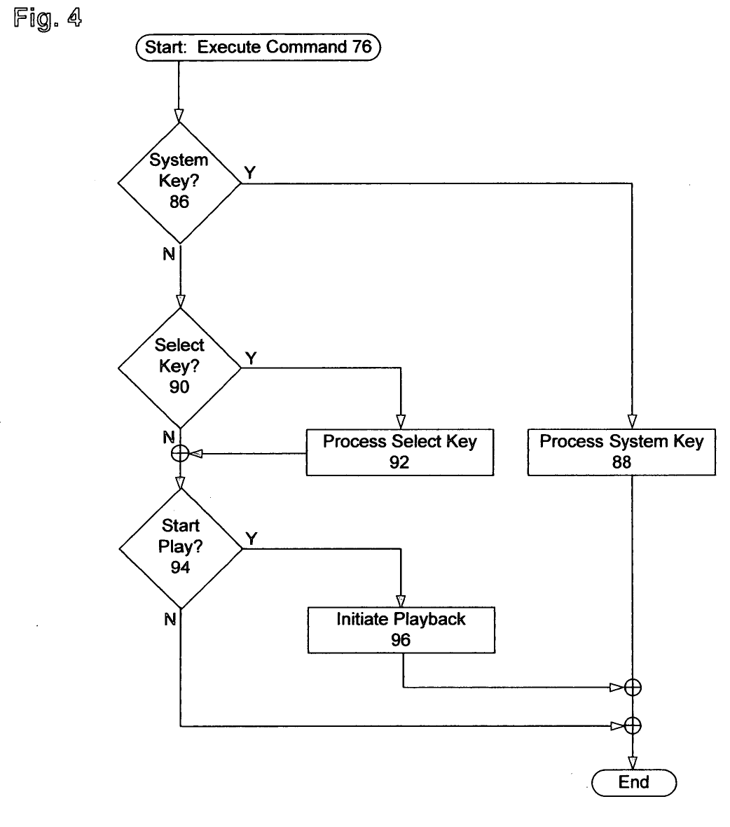

FIG. 4 shows some of the steps that can be included with the execute command step 76 of the software main loop. When started, this step tests for whether the key press being processed is a system key 86. If it is a system key, such as skip button 18 or a power button, then the software is directed to process the system key 88. If the key press is not a system key, then the system tests for a select key 90, such as a track selection key 20, so that it can process the select key 92. When done processing select keys, the system can either store the selection or start play 94 by initiating playback 96.

FIG. 5 shows some of the steps that can be included with the process select key step 92. If a first select key 100 has been entered, then the software will begin code 102 storage and play a first key sound 104. If it is not a first selection key that has been entered, then the software will complete code 106 storage and play a second key sound 108 followed by using the complete code selection to set to play 110 the user's song selection. Pressing buttons to change functions makes a barely audible click from today's durable switches, but selection keys of a vintage juke box were complicated mechanisms that made a slightly different sound when the final key for a selection was pressed, completing the selection of a song. The first and second key sound effects can be different, but the sound must be played by the amp and digital audio decoder almost immediately so that the sound is associated with a key press. When there is another song selection being played when a key press is detected, the key sounds should not be added to a playback memory and disturb music playback. Playing these key sounds can be an optional feature that a user may turn off.

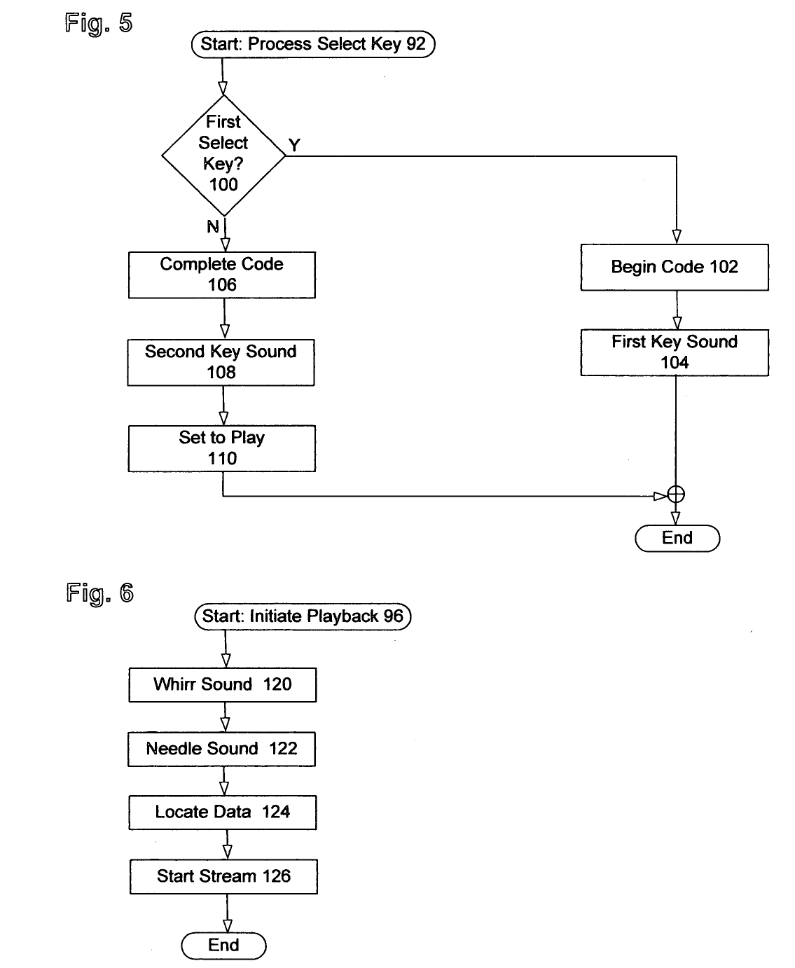

FIG. 6 shows some of the steps that can be included with the initiate playback step 96. When a user's song selection has been set to play 110 by the process select key step 92, the initiate playback step initiates the play of a whirr sound 120, followed by a needle sound 122 that emulates the crackling sound of a needle landing on a record that was heard before music would start to play. While these sound effects are still playing, the software is capable of moving to the locate data step 124 in parallel. The locate data step requires enough processing time that there would be a noticeable delay if the unit was silent, so the sound effects mask this delay by providing entertainment. Once the data needed to play a user's song is located, the system will start streaming 126 music to the amp and digital audio decoder 58. Preferably, the sound effects are sent to the same playback memory as the one used by the amp and digital audio decoder so there is a seamless playback of a song selection right after the sound effects finish playing.

The digital audio decoder 58 preferably includes a D-to-A converter (digital to analog converter) that has some type of DSP (digital signal processor). By having the D-to-A converter as part of the decoder, the sound effects just need to be sent to the decoder so that the MPU is free to move to the next software step, such as locate data. By sending the sound effects to some other hardware, we can parallel process the sound effects with the data locate, or some other software step of the MPU. A sound effects chip could be added to the MPU for this purpose, or be completely separate hardware part, but a preferred method is to include a playback memory in the decoder that has enough memory to store the sound effects as well as some of the audio data stream of a song selection that is stored in the digital audio storage unit 56. Because it is common for a decoder used for playback of MP3 files to be capable of playing variable bit rates, the sound effects can be played at a lower bit rate so that even more time can be allotted to a locate data step.

These sound effects can be generated before each song is played, but they should be able to be disabled for when a more modern style of operation is desired. Optionally, these sounds can just be generated before a first song selection is played, and then subsequent song selections are just played one after the other without sound effects. The customer should be allowed to decide how often they want to hear the sound effects, so a procedure for turning the sound effects feature off should be included.

While a preferred form of the invention has been shown and described, it will be realized that alterations and modifications may be made thereto without departing from the scope of the following claims.

What is claimed is:

1. A method for enhancing playback of digital audio data comprising the steps of:
storing sound effects in a digital audio player's playback memory;
initiate playback of at least one of the sound effects before an MPU of the player starts calculating a location of digital audio data stored in a song database;
loading at least some digital audio data from the song database into the playback memory while the sound effects are being played; and
continuing the playback of the digital audio data stored in the playback memory after the sound effects have been played.

2. The method of claim 1 wherein the playback memory includes a dedicated buffer.

3. The method of claim 1 wherein at least one of the sound effects emulates a sound made by a vintage juke box.

4. The method of claim 1 wherein at least one of the sound effects is characterized by a whirring sound followed by a crackling needle sound.

5. The method of claim 1 further comprising the step of storing at least one sound effect for playback immediately after a key press is detected.

6. The method of claim 1 further comprising the step of storing at least one sound effect within the song database.

7. The method of claim 1 further comprising the step of providing a means for at least partially turning off the sound effects.

8. A method for reducing intervals of silence associated with processing delays of a digital audio player comprising the steps of:
storing sound effects in a song database;
sending at least some of the sound effects to a playback memory;
playing the sound effects received by the playback memory;
calculating a location of digital music data stored in the song database at least partially while the sound effects are playing; and
continuing the playback of digital music after the sound effects finish playing.

9. The method of claim 8 further comprising the step of playing the digital music is characterized by streaming the digital music data to a digital audio decoder.

10. The method of claim 8 wherein the decoder is characterized by a subsystem that allows direct playback of uncompressed data.

11. The method of claim 9 wherein the decoder is characterized by a discrete digital to audio converter.

12. The method of claim 9 wherein the decoder uses a general purpose digital signal processor.

13. The method of claim 9 wherein the decoder is characterized by the ability to play variable bit rates, and wherein the sound effects are characterized by a lower bit rate than at least some of the audio data being located.

14. The method of claim 8 wherein at least one of the sound effects is a verbal response that distracts a user's attention away from the processing delays.

15. The method of claim 8 wherein at least one of the sound effects is associated with a famous person or cartoon character.

16. A method for creating a distraction that changes a user's perception about a juke box having a digital audio player comprising the steps of:
storing sound effects into ROM;
loading at least some of the sound effects into playback memory before an MPU of the player starts calculating a location of digital audio data stored in a song database;
playing the sound effects loaded into the playback memory substantially while the MPU locates data;
streaming digital audio data from the song database to a digital audio decoder; and
continuing playback of the streamed digital audio data after the sound effects finish playing.

17. The method of claim 16 wherein at least one of the sound effects emulates a sound made by a vintage juke box;

18. The method of claim 16 wherein the sound effects create an association with a vintage device such that a user expects delays that are normal for a vintage device.

19. The method of claim 16 further comprising the step of providing a means for at least partially turning off the sound effects.

20. The method of claim 16 further comprising the step of storing at least one key press sound effect that is only loaded into the playback memory after a key press is detected and there is no other digital audio data being played.
